(19) United States
(12) Patent Application Publication
(10) Pub. No.: US 2006/0026593 A1
(43) Pub. Date: Feb. 2, 2006

(54) Categorizing, voting and rating community threads

(75) Inventors: Benjamin Canning, Seattle, WA (US); Sabrina Kikkert, Seattle, WA (US); Stephen N. Anderson, Redmond, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 10/903,003

(22) Filed: Jul. 30, 2004

(51) Int. Cl. G06F 9/46

(52) U.S. Cl. 718/100

(57) ABSTRACT

A system and corresponding methods for categorizing a discussion thread is provided. In one embodiment, a method for categorizing a discussion thread includes receiving a request to initiate a discussion thread, determining a category for the discussion thread, categorizing the discussion thread based on the determined category, and creating the discussion thread. The category may be specified by an initiator of the discussion thread, for example, a poster of an initial post in the discussion thread.

### TECHNICAL FIELD

The described technology is directed to online community services and, more particularly, voting on and rating community threads based upon the votes.

### BACKGROUND

The world wide web (“Web”) provides an enormous distributed database of information interconnected by the Internet. The Internet is a world wide collection of thousands of networks that span over 100 countries and connect millions of computers. The number of users continues to grow rapidly and the Internet has quickly become a virtual means of communication, collaboration, commerce, entertainment, and the like.

The world wide connectivity and the rapidly growing number of Internet users is fostering the growth of online communities. A community is a virtual association of users who typically share a common interest. For example, communities form around topics such as politics, sports, hobbies, technology, and current events, to name a few.

Online discussion groups such as Usenet news groups, email lists, newsletters, bulletin boards, and forums, support these communities, including communication amongst the users in the communities. There are thousands of discussion groups covering a very large number of interests and generating a significant portion of the online content on the Internet. Many of the Internet users consider the content in these discussion groups to be the most important and useful content on the Internet.

The content in these discussion groups are in the form of messages posted by users. Typically, a user posts a message to a discussion group by filling out a form that includes the subject, the body of a message, and selecting a discussion group into which to post the message. A message, such as a question or a suggestion, that is not a reply to an earlier message starts a new thread. A thread is a series of messages that have been posted as replies to each other. A single discussion group typically contains many threads covering many topics. By reading the sequence of messages in a thread, a user is able to determine how the discussion has evolved.

Many companies provide and/or utilize discussion groups to foster communication regarding its products and services. Companies may provide discussion groups for users of one or more of their products to communicate with each other regarding the products. Moreover, representatives of the companies and/or other users knowledgeable about the products may monitor and participate in the discussion groups. For example, company representatives may monitor the discussion groups to obtain valuable information from users regarding its products, as well as to provide additional information to the users of its products through the various discussion groups.

A major drawback with using discussion groups as a mechanism for promoting communication between and amongst users interested in a product is the volume of information that is contained in the discussion groups. A discussion group may contain a large number of discussion threads, and each thread may further contain a large number of somewhat related messages posted by many users. Thus, it is very likely that the company and/or other interested users will have difficulty in reviewing the sheer volume of messages and discerning the relative importance of one message to another message.

Accordingly, a community services system and method that better manages the information contained in the discussion groups, for example, to assist users wade through the messages and threads in the discussion groups will have significant utility.

### SUMMARY

In one embodiment, a community services server system categorizes a discussion thread as either a “suggestion,” “question” or “other.” The system receives a request to initiate a new discussion thread and determines the category for the discussion thread based either on a specification of the category provided by an originator of the discussion board. The system then creates the requested discussion thread and records an indication of the category in an attribute assigned to the discussion thread.

In another embodiment, the system provides for filtering of discussion threads based on one or more characteristics of the discussion threads. The system filters the discussion threads by searching for the discussion threads that satisfy the one or more characteristics. The system then returns an indication of the discussion threads that satisfy the characteristics.

In still another embodiment, the system provides for voting for discussion threads by members of a community, and a rating of the discussion threads based on the number of votes. In yet another embodiment, the system provides for a rating of a discussion thread based on an initial structural categorization of the discussion thread.

These and other aspects, features, and disadvantages of the described technology will be set forth in the description that follows and possible embodiments thereof, and by reference to the appended drawings, that describe technology not being limited to any particular embodiment(s) thereof.

### BRIEF DESCRIPTION OF THE DRAWINGS

FIG. 1 is a block diagram illustrating an exemplary environment in which a facility may operate.

FIG. 2 is a block diagram illustrating selected components of a community services server computer, according to one embodiment.

FIG. 3 is a block diagram illustrating selected components of a feedback system computer, according to one embodiment.

FIG. 4 illustrates a flow chart of an exemplary method for processing a request to initiate a discussion thread, according to one embodiment.

FIG. 5 illustrates a flow chart of an exemplary method for determining a category for a discussion thread, according to one embodiment.

FIG. 6 illustrates a flow chart of an exemplary method for processing a request to make a suggestion, according to one embodiment.

FIG. 7 illustrates a flow chart of an exemplary method for processing a request to ask a question, according to one embodiment.

FIG. 8 illustrates a flow chart of an exemplary method for rating a discussion thread based on a number of votes, according to one embodiment.

FIG. 9 illustrates a flow chart of an exemplary method for providing a suggestion discussion thread directed to an organization to a member of the organization, according to one embodiment.

FIG. 10 illustrates a flow chart of an exemplary method for filtering discussion threads, according to one embodiment.

FIG. 11 illustrates a flow chart of an exemplary method for notifying a member of an organization of a post in a discussion thread, according to one embodiment.

FIG. 12 illustrates a flow chart of an exemplary method for rating a discussion thread based on a structural categorization of the discussion thread, according to one embodiment.

### DETAILED DESCRIPTION

A system and corresponding methods for categorizing, voting and rating community threads in an online community are provided. In one embodiment, a software facility (“facility”) categorizes a discussion thread subsequent to receiving a request to initiate the discussion thread. A discussion thread can be categorized as either a “suggestion,” “question” or “other” (e.g., none of the above). The category may be specified by a user selecting an indicator that an initial post in a discussion thread is a suggestion, a question or a comment (e.g., other). Alternatively, the facility may automatically determine the category of an initial post in a discussion thread. Because the post is the initial post in the discussion thread, the category of the post may be imported to the discussion thread and, thus, the discussion thread is also categorized.

In another embodiment, the facility provides discussion threads categorized as suggestion discussion threads to a backend service of a feedback system, which makes available the suggestion discussion threads to appropriate members of an organization. For example, the facility identifies a target organization for a suggestion discussion thread and provides the suggestion discussion thread to a backend service appropriate for the identified organization. A designated member of the organization, such as a responsible manager can then use the backend service to gain access to the suggestion discussion thread and appropriately act on the discussion thread. For example, the responsible manager can further categorize the suggestion discussion thread as a “bug,” “suggested design change,” and so forth. Moreover, the responsible manager can respond to a suggestion discussion thread by posting an official response from the organization. In a further aspect of the embodiment, the responsible manager is notified of posts made in the suggestion discussion thread subsequent to the official response made by the responsible manager.

In still another embodiment, the facility provides for voting for discussion threads and ratings for the discussion threads based on the number of votes. The votes may be tabulated at the individual post level or at the thread level to determine a rating for a discussion thread. Each vote may be weighted based on various characteristics of the voter, such as the voter's reputation in the community, the quality of posts made by the voter, the voter's voting history, the voter's affiliation, the number of posts made by the voter that are subsequently categorized as an “answer” post, and the like. The weight may also be based on various characteristics of the discussion thread, such as an overall quality of the thread, the number of highly valued posters who posted in the thread, the overall number of posts in the thread, and the like. In one application, a thread moderator, such as a responsible manager of an organization, can use the rating and voting data to focus on discussion groups having a predetermined level of priority or ranking, each of which is based on the rating and voting data. For example, a responsible manager may act on and respond to a suggestion discussion thread having a higher ranking before responding to a suggestion discussion thread having a lower ranking. Alternatively, the facility may rate a discussion thread based on an initial structural categorization of the discussion thread. For example, the facility may initially categorize a discussion thread as “simple,” “high activity,” “hot topic,” etc., based on the structure and/or contents of the discussion thread. The discussion thread can be rated based on this initial categorization.

In yet another embodiment, the facility provides for a filtering of the discussion threads. For example, a member of a community may request to view only certain discussion threads, such as suggestion discussion threads, question discussion threads, discussion threads that have not been answered or responded to, bugs, book reviews, code samples, how-to's, complaints, etc. The facility filters the discussion threads based on the specified attributes and returns or makes available the discussion threads satisfying the attributes to the requesting user. In one aspect of the embodiment, the facility provides the filtering feature to certain users in the community, such as discussion moderators, members of the community who have attained a certain status, for example, a preferred status, and the like.

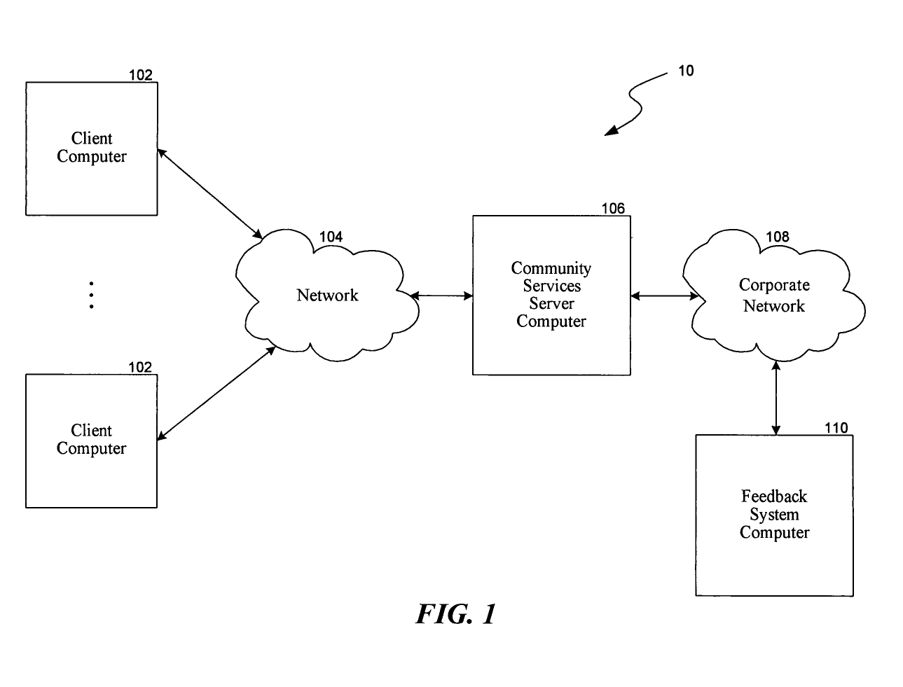

The various embodiments of the facility and its advantages are best understood by referring to FIGS. 1-12 of the drawings. The elements of the drawings are not necessarily to scale, emphasis instead being placed upon clearly illustrating the principles of the invention. Throughout the drawings, like numerals are used for like and corresponding parts of the various drawings.

FIG. 1 is a block diagram illustrating an exemplary environment 10 in which the facility may operate. As depicted, environment 10 includes one or more client computers 102 coupled to a community services computer 106, which is in turn coupled to a feedback system computer 110. In particular, client computers 102 and community services server computer 106 are coupled through a network 104, and community services server computer 106 and feedback system computer 110 are coupled through a corporate network 108.

Client computer 102 may be any type of computer system that provides its user the ability to load and execute software programs and the ability to access a network, such as, for example, network 104, and communicate with community services server computer 106. In one embodiment, client computer 102 is a personal computer executing a suitable operating system program that supports the loading and executing of application programs, such as a web browser or other suitable user interface program, for interacting with and accessing the services provided on community services server computer 106.

Network 104 is a communications link that facilitates the transfer of electronic content between, for example, the attached computers. In one embodiment, network 104 includes the Internet. It will be appreciated that network 104 may be comprised of one or more other types of networks, such as a local area network, a wide area network, a point-to-point dial-up connection, and the like.

In general terms, community services server computer 106 facilitates an online community by providing and managing the elements and services provided by the online community. The term “online community” or “community,” as used interchangeably herein, is a dynamic and virtual association of users in an online environment. Community services server computer 106 facilitates the online community by providing and managing elements such as, by way of example and not limitation, a home page, access control, communication, discussion groups, notification service, and the like.

Corporate network 108 is a communications link that facilitates the transfer of electronic content between, for example, the attached computers. In one embodiment, corporate network 108 is an intranet belonging to an organization, such as a corporation, accessible by the organization's members, employees, or others with authorization. Typically, a firewall (not depicted) surrounds the intranet and fends off unauthorized access. It will be appreciated that, in certain embodiments, corporate network 108 may be implemented as part of network 104.

In general terms, feedback system computer 110 facilitates a feedback system for an organization by providing access to community services server computer 106. Feedback system computer 110 functions as an interface between its users, such as the authorized members of an organization to which feedback system computer 110 belongs, and the online communities and, in particular, the posts and discussion threads provided on community services server computer 106. Feedback system computer 110 enables an organization to leverage the online communities to provide a public forum for users (e.g., members of the online communities) to submit feedback to the organization, to appropriately act on the submitted feedback, and to close the feedback loop with the users as described herein.

The computer systems of client computer 102, community services server computer 106 and feedback system computer 110 may include a central processing unit, memory, input devices (e.g., keyboard and pointing devices), output devices (e.g., display devices), and storage devices (e.g., disk drives). The memory and storage devices are computer-readable media that may contain instructions that implement the facility.

Environment 10 is only one example of a suitable operating environment and is not intended to suggest any limitation as to the scope of use or functionality of the facility. Other well-known computing systems, environments, and configurations that may be suitable for use include client computers, server computers, hand-held or laptop devices, multiprocessor systems, microprocessor-based systems, programmable consumer electronics, network PCs, minicomputers, mainframe computers, distributed computing environments including any of the above systems or devices, and the like.

The facility may be described in the general context of computer-readable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

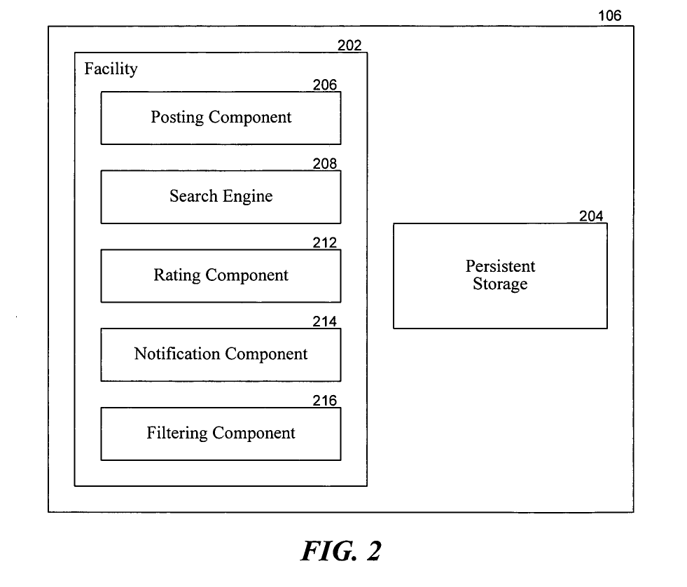

FIG. 2 is a block diagram illustrating selected components of community services server computer 106, according to one embodiment. As depicted, community services server computer 106 comprises a facility 202 and a persistent storage 204. It will be appreciated that community services server computer 106, as well as feedback system computer 110 further described below, includes other components that are typically found on a computer suitable for hosting facility 202 as described herein. For example, community services server computer 106 also includes a processing unit, memory, network interface, input/output interfaces and devices, and the like.

Facility 202 generally functions to provide access to the community and the services and features supported by the community. In particular, facility 202 contains the logic for managing the discussion groups that are provided by the community and enabling the community members to post messages in the discussion groups, view posted messages in the discussion groups, vote for posted messages and/or discussion threads, and the like.

In various embodiments, facility 202 provides enhanced community services by categorizing the discussion threads in the discussion groups. For example, when a user initiates a discussion thread, facility 202 designates the discussion thread as either a suggestion, a question, or some other category that describes the nature of the post. Based on the categorization of the discussion threads, facility 202 enhances a user's experience in interacting within the community by, for example, enabling the user to access discussion threads based on its category, providing certain categories of discussion threads to a backend service for further processing, enabling further categorization of discussion threads based on the initial categorization, and the like.

In other embodiments, facility 202 minimizes duplication of posts in the discussion groups by encouraging users to associate with existing posts rather than making new posts. For example, when a user requests to post a message, facility 202 performs a search of the posts in the discussion groups and provides to the user an opportunity to vote for a matching or a related post (e.g., a similar post) instead of posting a new message, and rates the posts and/or the discussion threads based on the voting.

As depicted in FIG. 2, facility 202 comprises a posting component 206, a search engine 208, a rating component 212, a notification component 214 and a filtering component 216. Posting component 206 generally functions to post messages into discussion groups provided by the community. In one embodiment, posting component 206 is implemented as one or more pages (e.g., user interfaces) that provides its user a streamlined user experience for posting a message (e.g., submitting a question or a suggestion) into the community without requiring the user to first browse the full community experience.

By way of example, posting component 206 may display to a user requesting to post a message, a page that requests the subject of the message. The page may contain logic to request a search of existing posts to identify posts that are similar to the subject of the message. Posting component 206 may display to the user another page that displays a number of threads that contain the similar posts that were found during the search. The number of threads to display may have been previously specified by, for example, a system administrator. The user can then view the posts in the displayed threads to determine whether or not to continue with posting the message. If the user elects to continue with posting the message, posting component 206 may display to the user still another page that assists the user in posting the message into a discussion group. If the message is an initial post in a discussion thread, the page provides the user the ability to specify a category for the post and/or the discussion thread or to request automatic categorization of the post and/or the discussion thread.

By way of another example, posting component 206 may display to a user requesting to post a suggestion a page that request from and enables the user to enter the suggestion in a brief sentence, for example, four to ten words. The page may contain logic to request a search of existing suggestions in the discussion groups to identify similar suggestions that have already been made. Posting component 206 may display to the user another page that displays a number of threads that contain the similar suggestions that were found during the search. The user can then view the similar suggestions to determine whether the suggestion has already been made. If the suggestion has already been made, the user can vote on the similar suggestion. Otherwise, the user can request to post the suggestion and posting component 206 may display to the user still another page that assists the user in posting the suggestion.

By way of still another example, posting component 206 may display to a user requesting to post a question a page that request from and enables the user to enter the question in a brief sentence, for example, four to ten words. The page may contain logic to request a search of existing questions in the discussion groups to identify similar questions that have been answered. Posting component 206 may display to the user another page that displays a number of threads that contain the similar questions that have been answered that were found during the search. The user can then view the similar questions and answers to determine whether the question has already been answered. If the question has not been answered, the user can request to post the question and posting component 206 may display to the user still another page that assists the user in posting the question. It will be appreciated that posting component 206 may include other pages and logic to enable and assist a user interact with the discussion groups and the posts contained in the discussion groups.

Search engine 208 contains logic to search the existing posts in the discussion groups for certain words or phrases. In one embodiment, search engine 208 is implemented as a text search engine. For example, search engine 208 receives a subject of a post, a number of words describing a suggestion, or a number of words describing a question. Search engine 208 generates keywords from the received input (e.g., by eliminating the articles and other commonly used words) and performs a text search of the posts in the discussion groups for the keywords as search terms and returns a result set (e.g., a list of discussion threads composed of at least one post that contain at least one keyword). It will be appreciated that search engine 208 may be implemented using other searching methods and technologies.

In another embodiment, search engine 208 is implemented as a text search engine that performs a selective search of the posts in the discussion groups based on a category of the potential post. For example, if a potential post is a suggestion, search engine 208 performs a search of the suggestion posts in the discussion groups, and if a potential post is a question, search engine 208 performs a search of the answered question posts in the discussion groups.

Rating component 212 contains logic to rate the discussion threads. In one embodiment, rating component 212 rates the discussion threads based on a sum of the total number of votes tabulated either at the post level or at the thread level. In another embodiment, rating component 212 rates the discussion threads based on a normalized number of votes. For example, a discussion thread composed of a high number of posts may inappropriately be rated higher than a discussion thread composed a fewer number of posts. In this embodiment, rating component 212 normalizes the number of votes received by a discussion thread by the overall number of posts in the discussion thread, as a divisor.

In still another embodiment, rating component 212 rates the discussion threads based on a sum of weighted votes. A weighted vote is calculated by applying a weight to a vote, where the weight is determined from a measurement of one or more characteristics or traits of the voter, such as, by way of example, the voter's reputation, a rating of the voter's other posts, the consistency with which the voter votes, the age in the community (e.g., the length of time the voter has been participating in the community), the voter's affiliation or status in the community, the number of answer posts posted by the voter, the frequency with which the voter votes, and the like. Some of the characteristics may positively impact the weight while certain other characteristics may negatively impact the weight. For example, voting too frequently or not frequently enough, as determined by respective thresholds such as a number of votes over a duration of time, may negatively impact the weight, while voting with a frequency in between the two thresholds may positively impact the weight. Likewise, a favorable reputation, as indicated by a position in a reputation scale, may positively impact the weight, while a less favorable reputation may negatively impact the weight. Each characteristic may be represented by a scale, and a measurement of a voter's characteristic or trait is indicated by a value or position within the scale.

Moreover, each characteristic or trait may have a different impact on the weight applied to the vote. Stated another way, one characteristic may have a greater impact on the weight than another characteristic. For example, a voter's reputation may have a greater impact on the weight than the consistency with which the voter votes. The impact of each characteristic or trait may be represented by another weight, which is applied to the value of the respective characteristic or trait. The weighted values may be summed to determine an overall weight to apply to the vote. It will be appreciated that the other characteristics or traits may also be used in determining the weight.

In yet another embodiment, rating component 212 rates the discussion threads based on the hierarchy of the discussion threads. In this embodiment, rating component 212 categorizes a discussion thread based generally on one or more attributes of the discussion thread. The attributes specify, for example, the structure of the discussion thread, the contents of the discussion thread, the subject or topic of the discussion thread, the level of activity and/or participation in the discussion thread, and other characteristics that describe the discussion thread. For example, a discussion thread composed of a question post followed by a series of posts responding to the question, or a post directed to an organization followed by a response post from the organization may be categorized as a “simple” discussion thread. Alternatively, a discussion thread composed of a large number of posts may be categorized as a “high activity” discussion thread, while a discussion thread composed of a large number of posts made by high quality posters (e.g., posters having a high reputation or certain affiliation) or a discussion thread having a high vote count may be categorized as a “hot topic” discussion thread. This category information may be used as a factor in determining a rating for the discussion thread.

It will be appreciated that the discussion threads may be categorized into categories other than those listed based on one or more attributes of the discussion threads. Moreover, the categories may be prioritized to account for the situation where a discussion thread can be categorized into multiple categories, for example, if a discussion thread can be categorized as both a “high activity” and a “hot topic” discussion thread.

For example, a discussion thread categorized as a “question-and-answer” discussion thread is compared to a template of a question-and-answer model thread, a discussion thread categorized as a “simple” discussion thread is compared to a template of a simple model thread, and so forth, to calculate a metric that indicates the similarity or difference between the discussion thread and a corresponding template model thread. Rating component 212 can then rate a discussion thread based on the calculated metric. For example, a discussion thread having a hierarchy closer or more similar to the template is rated higher than a discussion thread having a hierarchy that is not as close or as similar to the template.

Notification component 214 contains logic to provide an indication of the occurrence of certain conditions or events. Methods of notification include, but are not limited to, email, text messaging, wired or wireless calls to communication devices, alerts provided upon login to an account, etc. For example, notification component 214 notifies a poster that posted a message, such as a suggestion or a question, of posts made in response to and/or posts made subsequent to the poster's message.

Filtering component 216 contains logic to filter the existing posts in the discussion groups based on one or more specified attributes. Filtering component 216 identifies the existing posts in the discussion groups that satisfy the filter attributes and returns a list of discussion threads that contain at least one identified post. For example, a user may use one or more pages provided by facility 202 to request retrieval of question posts that have been posted within the last twenty-four hours and that have not been answered. Filtering component 216 would search for and identify the existing posts in the discussion groups that satisfy the filtering criteria and return a list of discussion groups that contain the requested question posts that have been posted within the last twenty-four hours which have yet to be answered. In one embodiment, filtering component 206 may perform the filtering by performing a search of the metadata associated with the posts and/or discussion threads. Metadata is further discussed below.

Persistent storage 204 is a computer-readable storage medium that persistently stores the computer programs and data, including data structures, on community services server computer 106. For example, persistent storage 204 stores the information and data associated with the community supported by community services server computer 106 including profile information regarding the members of the community, the discussion groups and discussion threads and their posts, category information, templates of model discussion threads, voting information and data, rating information, for an organization, a list of posts that are directed to the organization or posts that the organization may be interested in, for each member, information regarding the member's activities in the community, and the like. It will be appreciated that persistent storage 204 may store other content in addition to the content described.

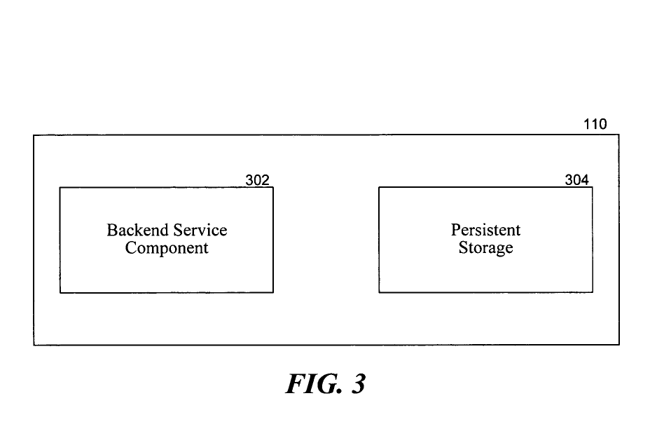

FIG. 3 is a block diagram illustrating selected components of feedback system computer 110, according to one embodiment. As depicted, feedback system computer 110 comprises a backend service component 302 and a persistent storage 304. Backend service component 302 generally functions to provide an interface between the community backend provided on community services server computer 106 and the backend services of the feedback system provided on feedback system computer 110.

In various embodiments, backend service component 302 contains logic for an interface to the data and information of the community provided on community services server computer 106. Examples of functions provided by the interface include the ability to query discussion threads and metadata regarding the discussion threads, the ability to query posts in the discussion threads and the metadata regarding the posts, the ability to build queries, the ability to view detailed information about a discussion thread, the ability to create and associate an issue to a discussion thread, and the like. An “issue” is generally the information and data regarding the topic or subject matter of the discussion thread.

As used herein, “metadata” is defined as “data about data.” As such, metadata regarding a post or a discussion thread includes data such as, by way of example, its category, identity of the poster or creator, the structure of the thread, size of the thread or post, voting data, rating or ranking, the associated issue, status information, and the like.

Backend service component 302 also contains logic for communicating and/or interacting with the community backend as well as the other components of feedback system computer 110 to process the requests received via the interface. The logic may also provide services that manage and perform operations on the discussion threads and the metadata as described herein. In one embodiment, backend service component 302 includes one or more pages, logic and/or program interfaces that provide its user the ability to build queries, view query results, post messages such as replies to threads, request items of information and data from the community and/or components of feedback system computer 110, sort posts and discussion threads based on criteria such as votes, rank, etc., create issues, for example, bug, design change, feature, etc., and assign the appropriate severity and/or priority, assign issues to other members of an organization, communicate with other members of an organization, request and receive alerts and reminders, assign attributes to the posts and discussion threads, perform diagnostics and analysis, and the like.

Persistent storage 304 is a computer-readable storage medium that persistently stores the computer programs and data, including data structures, on feedback system computer 110. For example, persistent storage 304 stores information and data regarding the organization to which feedback system computer 110 belongs, the members of the organization and the community to enable the components of feedback system computer 110 to function as a feedback system and a backend service for the organization. In one embodiment, persistent storage 304 replicates and stores some or all of the data and information regarding the communities provided on community services server computer 106, as well as the other data and metadata associated with the posts and discussion threads to facilitate the services and functions provided by feedback system computer 110.

The aforementioned components of community services server computer 106 and feedback system computer 110 are only illustrative, and computers 106 and/or 110 may include other components and modules not depicted. The depicted components and modules may communicate with each other and other components comprising, for example, community service server computer 106 through mechanisms such as, by way of example, interprocess communication, procedure and function calls, application program interfaces, other various program interfaces, and various network protocols. Additionally, the functionality provided for in the components and modules may be combined into fewer components and modules or further separated into additional components and modules. Furthermore, some or all of the functionality provided by feedback system computer 110 may be implemented in community services server computer 106.

In the discussion that follows, embodiments of facility 202 and backend service component 302 are described in conjunction with a variety of illustrative examples. It will be appreciated that the embodiments of facility 202 and backend service component 302 may be used in circumstances that diverge significantly from these examples in various respects.

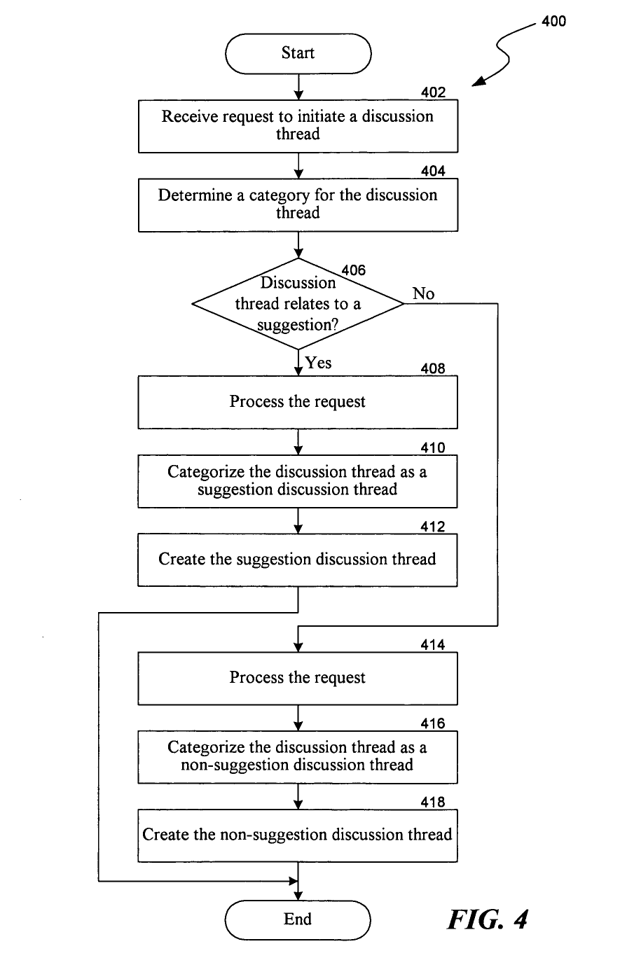

FIG. 4 illustrates a flow chart of an exemplary method 400 for processing a request to initiate a discussion thread, according to one embodiment. At step 402, facility 202 receives a request to initiate a discussion thread. By way of one example, a user may be executing a web browser program on client computer 102 and interacting with facility 202 executing on community services server computer 102. While browsing the various discussion groups, the user may submit a request to start a new discussion group by posting an initial message in a discussion group.

By way of another example, a user may be executing an application program, such as a word processor, on client computer 102. While using the application program, the user may become frustrated because of the inability or difficulty of performing a function. The user may activate a “contact us” link that is provided in a tool bar. The link provides the user the ability to make a suggestion or ask a question by posting a message directed to the manufacturer or developer of the application program.

At step 404, facility 202 determines a category for the discussion thread. Facility 202 may categorize the discussion thread according to the category assigned to the initial post in the discussion thread. In one embodiment, facility 202 categorizes the discussion thread as either a “suggestion,” “question,” or “other.” In other embodiments, discussion threads may be categorized as “bug reports,” “annotation threads,” etc.

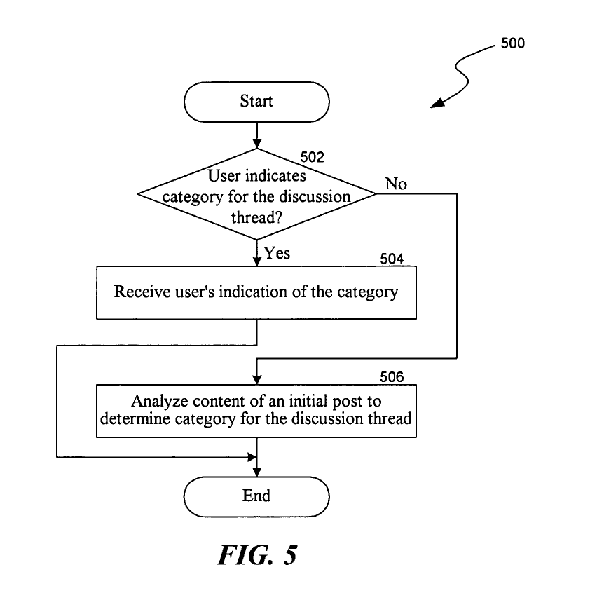

FIG. 5 illustrates a flow chart of an exemplary method 500 for determining a category for a discussion thread, according to one embodiment. At step 502, facility 202 checks to determine whether the user indicated a category for the discussion thread. For example, the user may have indicated the category by requesting to make a suggestion or ask a question regarding the functionality of the application program. In another example, facility 202 may provide the user the ability to select or indicate a category to associate with the user's initial post in a discussion thread, and the user may have accordingly specified a category. Alternatively, the user may have requested that facility 202 automatically categorize the initial post and, accordingly, the discussion thread.

If, at step 502, the user indicated a category for the discussion thread, facility 202 receives the user's indication of the category at step 504. Alternatively, if the user did not indicate a category or the user requested automatic categorization, facility 202 determines the category for the discussion thread at step 506. In one embodiment, facility 202 may analyze the contents, such as the subject and message body, of the initial post to determine an appropriate category. In another embodiment, facility 202 may also analyze other information and data, including metadata, related to the initial post and/or the discussion thread to categorize the discussion thread. Subsequent to determining the category of the discussion thread at either step 502 or step 506, method 500 proceeds to an end step.

Referring again to method 400, at step 406, facility 202 checks to determine if the discussion thread relates to a suggestion. Stated another way, facility 202 checks to see if the discussion thread is categorized as a “suggestion.” If the discussion thread is a suggestion thread, facility 202 processes the request to initiate a suggestion discussion thread at step 408. For example, facility 202 may present the user one or more pages through which the user enters the text of the suggestion.

At step 410, facility 202 categorizes the discussion thread as a suggestion discussion thread. In one embodiment, facility 202 records an indication of the category of the discussion thread in an attribute assigned to the discussion thread. The attribute indicates that the associated discussion thread is a suggestion thread. At step 412, facility 202 creates the suggestion discussion thread in an appropriate discussion group provided on community services server computer 106. In one embodiment, the suggestion discussion thread is categorized in terms of what organization it should initially go to on the basis of the discussion group. Then, members of the community are provided the opportunity to vote for the suggestion discussion thread. At some subsequent point in time, a report is generated that identifies the top vote-getting suggestion discussion threads, and these suggestion discussion threads are provided to the appropriate members of the organization. For example, members of a product team responsible for the suggestion, as determined on the basis of the discussion group, are provided notification of the identified suggestion discussion thread.

If, at step 406, facility 202 determines that the discussion thread does not relate to a suggestion, then, at step 414, facility 202 processes the request to initiate a non-suggestion discussion thread. For example, facility 202 may present the user one or more pages through which the user enters the text of a question. Alternatively, in the case where the user has not already provided the data and information, for example, the subject, message text, indication of a discussion group, etc., related to the initial post, facility 202 may present the user one or more pages through which the user enters the information and data of the initial post.

At step 416, facility 202 categorizes the discussion thread as one of the non-suggestion discussion threads. In one embodiment, facility 202 categorizes the discussion thread as either a “question” or “other,” and records the category indication in an attribute assigned to the discussion thread. At step 418, facility 202 creates the non-suggestion discussion thread in an appropriate discussion group provided on community services server computer 102. In one embodiment, for question discussion threads, facility 202 may identify an intended recipient of the question and provide the intended recipient an indication of the posted question. For example, facility 202 may determine the intended recipient from the information and data associated with the question post. Subsequent to creating the new discussion thread at either step 412 or step 418, facility 202 proceeds to an end step.

Those of ordinary skill in the art will appreciate that, for this and other processes and methods disclosed herein, the functions performed in the processes and methods may be implemented in differing order. Furthermore, the outlined steps are only exemplary, and some of the steps may be optional, combined with fewer steps, or expanded into additional steps without detracting from the essence of the invention.

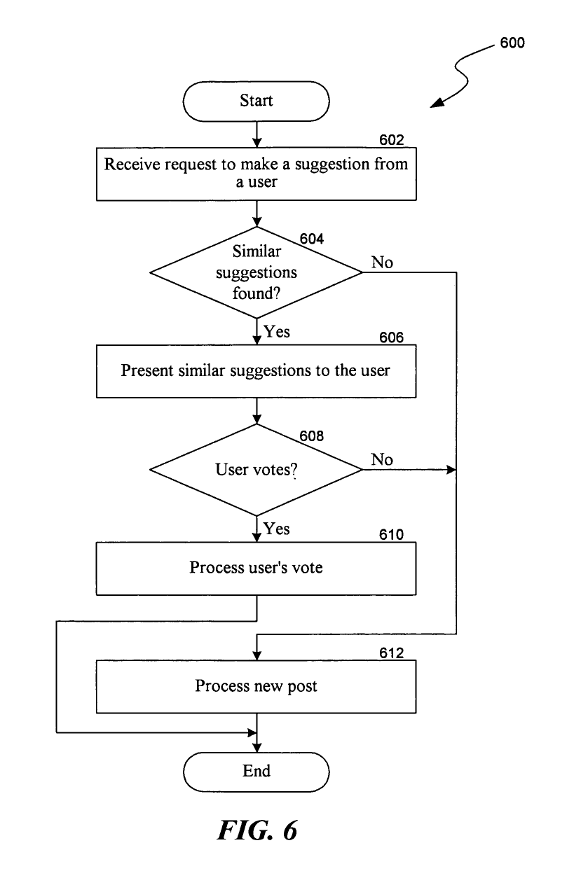

FIG. 6 illustrates a flow chart of an exemplary method 600 for processing a request to make a suggestion, according to one embodiment. By way of example, a user may be executing an application program, such as a word processor, on client computer 102. While using the application program, the user may become frustrated with the inability to perform a function. The user notices a “contact us” link that is provided in a tool bar, and activates the link to contact the manufacturer of the application program. In response, computer 102 displays a page through which the user is requested to provide a brief sentence describing the suggestion. The user provides the requested brief sentence in a text box, and activates a “continue” or “go” button provided on the page, causing client computer 102 to transmit the request to submit a suggestion to facility 202.

At step 602, facility 202 receives the user's request to make a suggestion. In particular, facility 202 receives the user's brief description of the suggestion. At step 604, facility 202 performs a search of the posts using the user-provided brief description of the suggestion for similar suggestions.

In one embodiment, facility 202 extracts keywords from the user-provided brief description and performs a text search of the posts in the suggestion discussion threads in the discussion groups provided by the community. In another embodiment, facility 202 searches the discussion groups associated with or scoped to the application program through which the user submitted the request to make the suggestion. For example, the application program may pass its URL or other suitable identifier with the user's request to make a suggestion to facility 202, enabling facility 202 to appropriately identify the application program.

If facility 202 finds similar suggestion posts, then, at step 606, facility 202 transmits a page displaying a list of the similar suggestion posts to client computer 102, causing client computer 102 to display the page. In one embodiment, the page displays links to the discussion threads containing the similar suggestion posts, which links can be used to access the posts in the discussion suggestion threads. The displayed page may provide the user the ability to review the suggestion discussion threads to see if the user's suggestion has already been made, and, if so, the ability for the user to submit a vote for the suggestion post or the suggestion discussion thread that is similar to the user's suggestion. The displayed page may also provide the user the ability to refine the search or to proceed with making the suggestion, for example, by posting an initial message in a discussion thread. The displayed page may include a text area where the user can enter additional text describing the suggestion. The display page may also provide the user with the ability to see the reputation of the post originator or respondents to the returned suggestion threads.

At step 608, facility 202 checks to determine if the user submitted a vote for a similar suggestion post or a suggestion discussion thread containing the similar suggestion post. If the user submitted a vote, facility 202 processes the user's vote at step 610. In one embodiment, facility 202 increments a count of the number of votes that is maintained in an attribute assigned to the particular post or the particular discussion thread. Facility 202 may also record information regarding the user that submitted the vote, for example, in one or more records associated with the post or the discussion thread.

Alternatively, if no similar suggestions were found at step 604 or the user did not submit a vote at step 608, and the user decides to proceed with making the suggestion, facility 202 processes the new post at step 612. In one embodiment, facility 202 creates a new discussion thread and posts the user's suggestion as an initial post in the newly created discussion thread. Subsequent to processing the user's vote at step 608 or posting the user's suggestion at step 612, facility 202 proceeds to an end step.

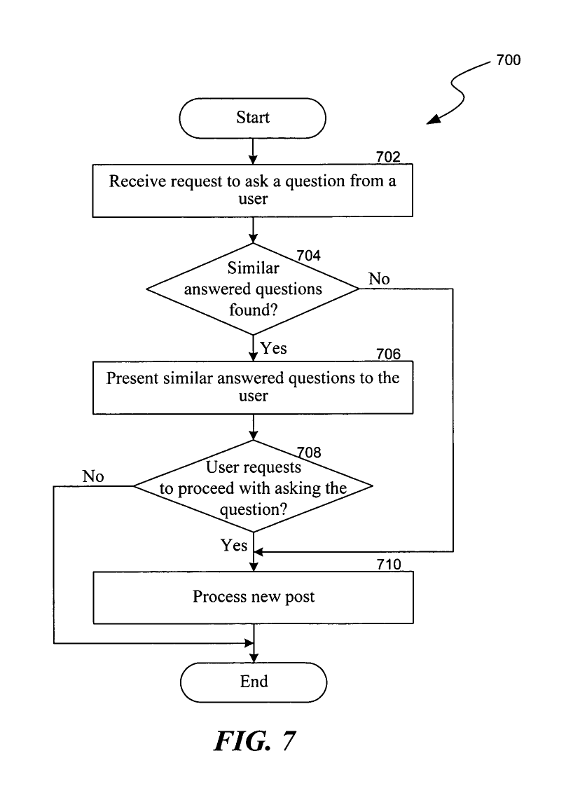

FIG. 7 illustrates a flow chart of an exemplary method 700 for processing a request to ask a question, according to one embodiment. Continuing the prior example, the user, while using the application program, may develop a question regarding the function of the application program. The user notices a “submit a question” link that is provided in a tool bar, and activates the link to ask a question to a community of users associated or affiliated with the application program and/or the manufacturer of the application program. In response, computer 102 displays a page through which the user is requested to provide a brief sentence describing the question. The user provides the requested brief sentence in a text box, and activates a “continue” or “go” button provided on the page, causing client computer 102 to transmit the request to ask the question to facility 202.

At step 702, facility 202 receives the user's request to ask a question. In particular, facility 202 receives the user's brief description of the question. At step 704, facility 202 performs a search of the posts using the user-provided brief description of the question for similar questions.

In one embodiment, facility 202 extracts keywords from the user-provided brief description and performs a text search of posts designated as “answered questions” in the discussion groups. For example, an original poster of a question may review posts made in response to the question and, finding a post that satisfactorily answers the question, designate that post as an answer post. In response, facility 202 can mark the discussion thread containing the answered question post as an answered question discussion thread. In another embodiment, facility 202 searches the discussion groups associated with or scoped to the application program through which the user submitted the request to ask the question.

If facility 202 finds similar question posts that have been answered, then, at step 706, facility 202 transmits a page displaying a list of discussion threads containing the similar question posts that have been answered to client computer 102, causing client computer 102 to display the page. The displayed page may provide the user the ability to review the discussion threads to see if the user's question has been asked and answered. The displayed page may also provide the user the ability to refine the search or to proceed with asking the question, for example, by posting an initial message in a discussion thread. The displayed page may include a text area where the user can enter additional text describing the question. The display page may also provide the user with the ability to see the reputation of the post originator or respondents to the returned suggestion threads.

At step 708, facility 202 checks to determine if the user requests to proceed with asking the question. If the user decides to proceed with asking the question, or if facility 202 was unable to find any similar question posts that have been answered, facility 202 processes the new post at step 710. In one embodiment, facility 202 creates a new discussion thread and posts the user's question as an initial post in the newly created discussion thread. Subsequent to posting the user's question, facility 202 proceeds to an end step.

In another embodiment, facility 202 may also search the question posts that have not been answered for similar questions. For example, the user may make a request for this search upon not finding a similar question post that has been answered. Facility 202 can then perform the search and transmit a page displaying a list of the discussion threads containing the similar question posts that have not been answered to client computer 102, causing client computer 102 to display the page. The displayed page may provide the user the ability to review the similar question posts in the discussion threads to see if the user's question has already been asked and, if so, the ability for the user to submit a vote for the question post or the question discussion thread that is similar to the user's question.

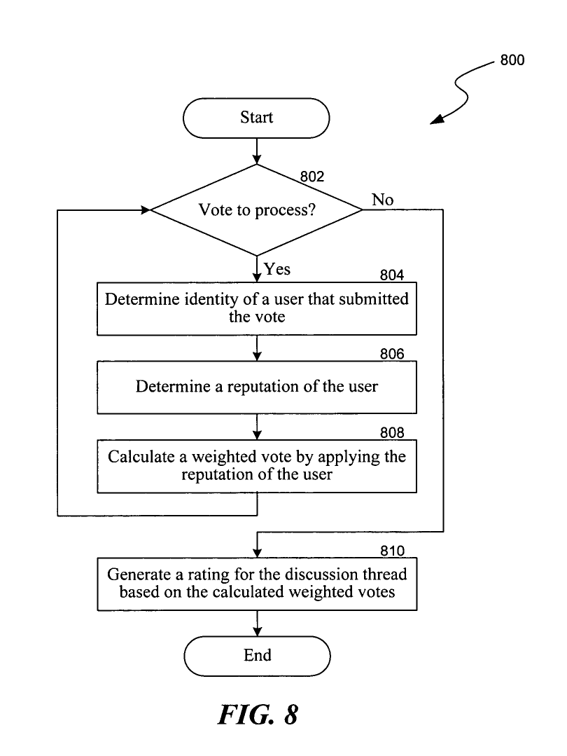

FIG. 8 illustrates a flow chart of an exemplary method 800 for rating a discussion thread based on a number of votes, according to one embodiment. By way of example, facility 202 may rate a discussion thread subsequent to a user submitting a vote or in response to receiving a request to rate the discussion threads. At step 802, facility 202 checks to determine if there is a vote to process for a discussion thread. In one embodiment, a count of the number of votes is maintained in an attribute assigned to the discussion thread or attributes assigned to respective posts in the discussion thread.

If there is a vote to process, facility 202 determines the identity of the user that submitted the vote identified as needing to be processed at step 804. At step 806, facility 202 determines the reputation of the identified user. The reputation of the user may be determined by analyzing one or more characteristics or traits associated with the user, where each characteristic either positively or negatively impacts the user's reputation.

At step 808, facility 202 calculates a weighted vote based on the user's reputation for the vote currently being processed. In one embodiment, facility 202 assigns a value to each characteristic used in determining the user's reputation, where each value is an indication of the respective characteristic as applied to the user. Facility 202 then adjusts each value according to the impact of the respective characteristic in determining the user's reputation. Facility 202 calculates an overall weight by summing the weighted values, and applies the overall weigh to the vote to calculate a weighted vote. Because a vote typically has a unit value (e.g., each vote is counted as having a value of one), the weighted vote may be calculated by summing the weighted values. Subsequent to calculating the weighted vote, facility 202 returns to step 802 to determine if there is another vote to process for the discussion thread.

If there are no more votes to process for the discussion thread (e.g., facility 202 processed all the votes and calculated the respective weighted votes), then, at step 810, facility 202 generates a rating for the discussion thread based on the calculated weighted votes. In one embodiment, facility 202 calculates a rating score that represents the rating by summing the weighted votes. Subsequent to generating a rating for the discussion thread, facility 202 proceeds to an end step.

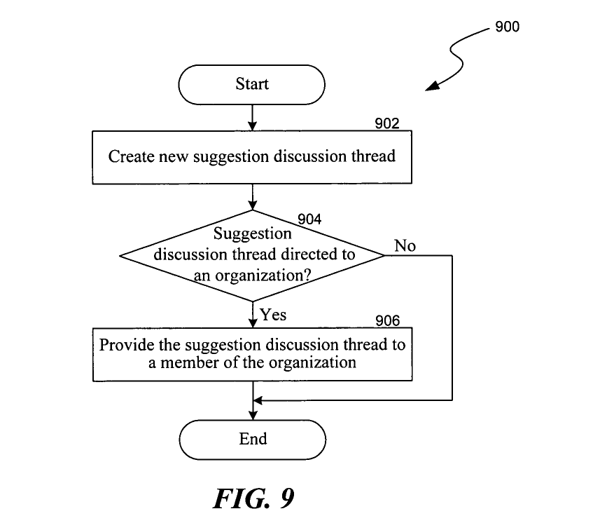

FIG. 9 illustrates a flow chart of an exemplary method 900 for providing a suggestion discussion thread directed to an organization to a member of the organization, according to one embodiment. By way of example, a user may have posted an initial post in a suggestion discussion thread through a hyperlink provided in a tool bar of an application program.

At step 902, facility 202 creates a new suggestion discussion thread. At step 904, facility 202 checks to determine if the new suggestion discussion thread is directed to an organization. For example, if the suggestion discussion thread was initiated through an application program, the application program may have provided an indication of an organization that is the intended recipient of the suggestion. Alternatively, facility 202 may attempt to identify an organization that is the intended recipient from data and information associated with the suggestion discussion thread.

If facility 202 identifies the organization that is the intended recipient of the new suggestion discussion thread, then, at step 906, facility 202 provides notification of the new suggestion discussion thread to one or more designated members of the organization. For example, facility 202 may maintain records that store information regarding the members of the organization to notify of the creation of a new suggestion discussion thread directed to the organization. In one embodiment, facility 202 provides the appropriate members of the organization an indication of the newly created suggestion discussion thread. The indication may be by, for example, e-mail, text message, recorded message to a communication device, alert provided upon logging into an account, etc. Subsequent to providing a notification of the creation or initiation of the new suggestion discussion thread to designated members of the organization, or if facility 202 fails to identify an intended recipient organization at step 904, facility 202 proceeds to an end step. In another embodiment, facility 202 provides notification of the suggestion discussion threads that garner enough votes to rise to the surface, for example, the suggestion discussion threads that garner more votes than the remaining suggestion discussion threads. This enables each organization to look at the top N vote-getting suggestions each month, quarter, etc.

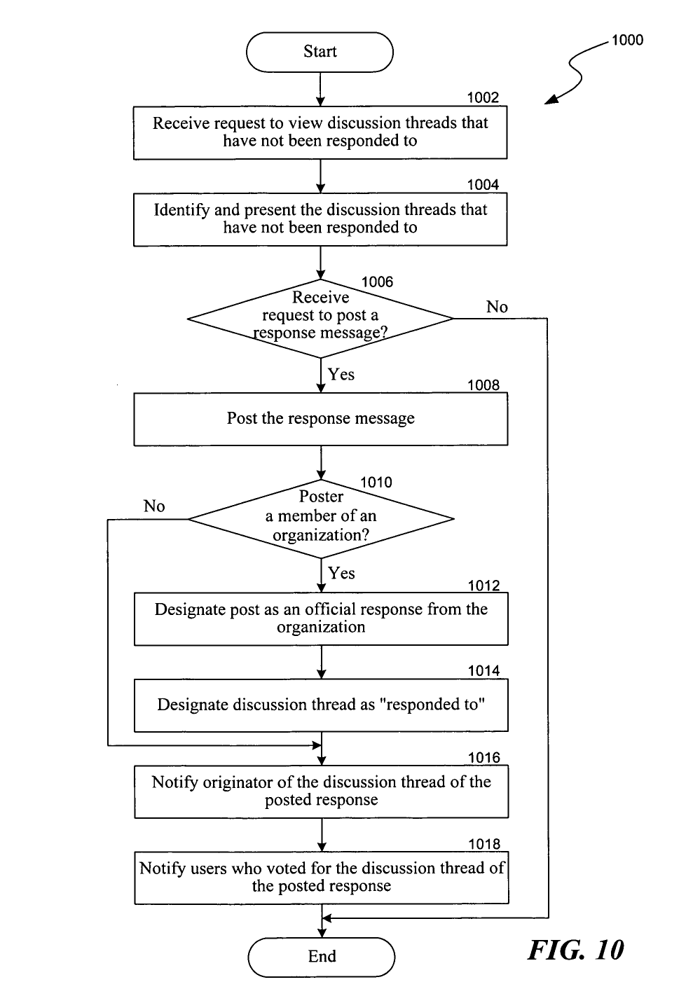

FIG. 10 illustrates a flow chart of an exemplary method 1000 for filtering discussion threads, according to one embodiment. By way of example, a program manger of an organization responsible for an application program developed by the organization may utilize feedback system computer 110 to query the discussion groups that apply to the application program.

At step 1002, facility 202 receives a request to view discussion threads that apply to the application program, and which have not been responded to. At step 1004, facility 202 identifies the discussion threads that have not been responded to in the discussion groups that apply to the application program. Facility 202 then presents the identified discussion groups, for example, in a page that displays links to the identified discussion groups. In one embodiment, facility 202 filters the discussion threads by checking the metadata assigned to each discussion thread for an indication that the discussion thread has not been responded to. Similarly, facility 202 may check the metadata for average rating information, number of votes, etc., based on the filtering characteristics.

At step 1006, facility 202 checks to determine whether it receives a request to post a response message. For example, the program manager may view the posts in an identified discussion thread and decide to post a response message. If facility 202 receives a request to post a response message, facility 202 posts the response message at step 1008.

At step 1010, facility 202 checks to determine whether the poster of the response message is a member of an organization. For example, the response message may have been posted by a user knowledgeable about the application program but who is not a member of the organization. If the poster is a member of the organization, such as the program manager, facility 202 designates the post as an official response from the organization at step 1012. At step 1014, facility 102 designates the discussion thread containing the posted response as “responded to.” Facility 202 may indicate the designations in respective attributes assigned to the post and the discussion thread.

Upon determining that the poster of the response message is not a member of the organization, or subsequent to designating the discussion thread as responded to, facility 202 notifies the originator of the discussion thread of the posted response at step 1016. At step 1018, facility 202 notifies the users who submitted votes for the discussion thread of the posted response. The identities of the creator of the discussion thread and the voters who submitted votes for the discussion thread may be maintained in attributes assigned to the discussion thread, and the contact information may be maintained in the respective user profiles. Subsequent to determining that there is no response message to post or notifying the appropriate users of the posted response, facility 202 proceeds to an end step.

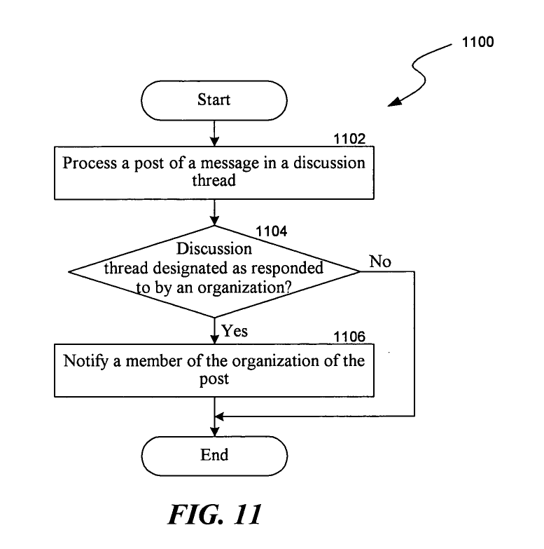

FIG. 11 illustrates a flow chart of an exemplary method 1100 for notifying a member of an organization of a post in a discussion thread, according to one embodiment. By way of example, a member of an organization, such as a company's program manager who is responsible for a particular feature or function of a product, may have utilized feedback system computer 110 and previously posted a response message to a suggestion post in a suggestion discussion thread. Backend service component 302 on feedback system compute 110 may have designated, in an attribute, the response message as an official response from the organization. In one embodiment, facility 202 monitors posts being made to detect posts being made in discussion threads that have been officially responded to by the appropriate organization. This allows facility 202 to trigger on this event and provide the organization notification of further activity in the discussion group.

At step 1102, facility 202 processes a post of a message in a discussion thread. At step 1104, facility 202 checks to determine if the discussion thread is designated as being officially responded to by the appropriate organization. If the discussion thread is designated as having been officially responded to by the organization, facility 202 notifies a member of the organization of the post made subsequent to the official response posted by the organization at step 1106. In one embodiment, facility 202 sends a notification e-mail to the program manager responsible for the subject of the discussion thread. The program manager's email address, or other contact information may be retrieved from the member's profile maintained by facility 202. In another embodiment, facility 202 may send the notification to backend service component 302, which in turn notifies the appropriate member of the organization of the post. Subsequent to notifying the member of the organization or determining that the discussion thread is not one which has been officially responded to by an organization, facility 202 proceeds to an end step.

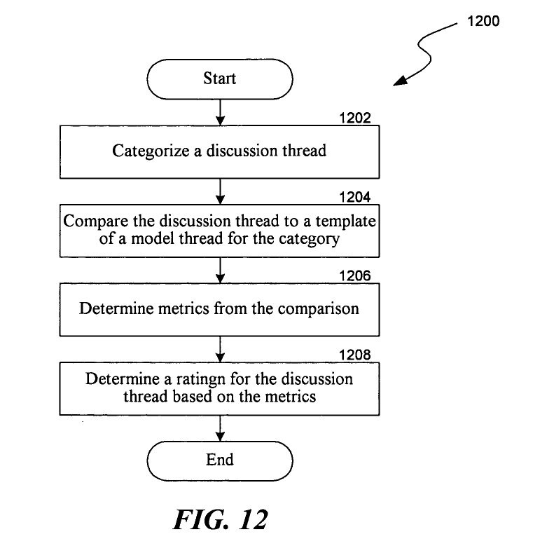

FIG. 12 illustrates a flow chart of an exemplary method 1200 for rating a discussion thread based on a structural categorization of the discussion thread, according to one embodiment. Here, a discussion thread is initially categorized based on one or more attributes of the discussion thread, and then the hierarchy of the discussion thread is compared to a template of a model thread for the determined category of discussion thread.

At step 1202, facility 202 categorizes the discussion thread based on one or more attributes, such as, by way of example, the activity or participation in the discussion thread. In one embodiment, facility 202 categorizes the discussion thread as either “simple,” “highly active” or “hot topic.” Facility 202 may store an indication of the category designation in an attribute assigned to the discussion thread. At step 1204, facility 202 compares the structure or organization (e.g., hierarchy) of the discussion thread to a template of a model thread for the category. Facility 202 maintains a template of the structure or organization of a model thread for each of the categories “question-and-answer,” “simple,” “highly active” and “hot topic,” and compares the structure of the discussion thread to the appropriate template.

At step 1206, facility 202 determines one or more metrics from the comparison of the discussion thread to the template of the appropriate model thread. One metric may be a measurement of the divergence of the structure of the discussion thread to the structure of the template. Another metric may be the difference in the number of posts in the discussion thread and the template. Still another metric may be the difference between the number of different posters in the discussion thread to an expected number of different posters.

At step 1208, facility 202 determines a rating for the discussion thread based on the metrics. In one embodiment, facility 202 may assign a value to each metric, where the value is a number in a scale, for example, a scale from “1” to “10.” Facility 202 may then determine a weight, for example, between 0% and 100%, for each metric based on the impact of the metric in determining the rating. Moreover, the impact of a metric may vary based on the categorization of the discussion thread as either “simple,” “highly active” or “hot topic.” For each metric, the weight is applied to the value assigned to the metric, for example, by multiplying the weight to the value, to generate a weighted value for the metric. Facility 202 calculates a rating for the discussion thread by summing the weighted values. Subsequent to rating the discussion thread, facility 202 proceeds to an end step.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

We claim:

1. A method for categorizing discussion threads comprising:
receiving a request to initiate a discussion thread;
determining a category for the discussion thread;
categorizing the discussion thread based on the determined category; and
creating the discussion thread.

2. The method of claim 1, wherein the category is indicated by a user creating the discussion thread.

3. The method of claim 1, wherein the category is determined by analyzing metadata related to the discussion thread.

4. The method of claim 1, wherein the category is a suggestion.

5. The method of claim 1, wherein the category is a question.

6. A method for processing a request to post a suggestion in a discussion group, the method comprising:
receiving a request to make a suggestion from a user;
searching existing posts in discussion threads for posts that are suggestions similar to the user's suggestion; and
responsive to finding posts that are suggestions similar to the user's suggestion, presenting the found posts for review by the user.

7. The method of claim 6 further comprising receiving a submission of a vote for one of the posts presented for review by the user.

8. The method of claim 6 wherein the request to make a suggestion from the user is received through an application program.

9. The method of claim 6 further comprising:
receiving a request to post the suggestion from the user; and
posting the suggestion as an initial post to a new discussion thread.

10. The method of claim 9 further comprising:
determining an intended recipient of the posted suggestion; and
providing the intended recipient an indication of the posted suggestion.

11. The method of claim 10, wherein the intended recipient is a member of an organization.

12. The method of claim 10, wherein the indication is by an email message.

13. The method of claim 10, wherein the indication is by a text message.

14. The method of claim 10, wherein the indication is by a notification upon login.

15. The method of claim 10 further comprising:
receiving a request to post a response message to the posted suggestion; and
responsive to determining that the request to post response message is from the intended recipient, indicating the new discussion thread as responded to by the intended recipient.

16. The method of claim 15 further comprising notifying the user of the posted response message.

17. The method of claim 15 further comprising notifying voters who submitted votes for the posted suggestion of the posted response message.

18. The method of claim 15 further comprising:
receiving a request to post a message to the new discussion thread indicated as responded to by the intended recipient;
posting the message to the new discussion thread indicated as responded to by the intended recipient; and
notifying the intended recipient of the newly posted message.

19. A method for processing a request to post a question in a discussion group, the method comprising:
receiving a request to ask a question from a user;
searching existing posts in discussion threads for posts that are questions similar to the user's question; and
responsive to finding posts that are questions similar to the user's question, presenting the discussion threads containing the found posts for review by the user.

20. The method of claim 19 further comprising receiving a vote for a discussion thread containing one of the found posts.

21. The method of claim 19 wherein the request to ask a question is made through an application program.

22. The method of claim 19 wherein the searching of existing posts is in question discussion threads that have been answered.

23. The method of claim 19 further comprising:
receiving a request to post a message asking the question; and
posting the message as an initial post in a new discussion thread.

24. The method of claim 23 further comprising:
posting a second message in the new discussion thread;
receiving an indication from the user that the second message is an answer post; and
indicating the new discussion thread as an answered question discussion thread.

25. A method for filtering discussion threads comprising:
receiving a request to view discussion threads that satisfy one or more filtering characteristics;
selecting the discussion threads that satisfy the one or more filtering characteristics; and
displaying an indication of the selected discussion threads.

26. The method of claim 25 wherein the filtering characteristics specify discussion threads that are suggestion discussion threads.

27. The method of claim 26 wherein the filtering characteristics further specify suggestion discussion threads that have not been officially responded to by an organization.

28. The method of claim 25 wherein the filtering characteristics specify discussion threads scoped to a product.

29. The method of claim 25 wherein the filtering characteristics specify discussion threads that contain a question.

30. The method of claim 29 wherein the filtering characteristics specify discussion threads that contain a question that has not been answered.

31. A method for rating a discussion thread comprising:
receiving votes for a discussion thread, the votes being cast by users and indicating preference of the discussion thread as specified by a user casting the vote;
determining a weight to apply to a vote cast by a user, the weight being determined from one or more traits of the user; and
generating a rating for the discussion thread based on a number of received votes and each vote's respective weight.

32. The method of claim 31 further comprising normalizing the number of votes.

33. The method of claim 31 wherein the one or more traits include a reputation of the user.

34. The method of claim 31 wherein the one or more traits include a rating of the user's other posts.

35. The method of claim 31 wherein the one or more traits include an indication of the consistency with which the user votes.

36. The method of claim 31 wherein the one or more traits include an indication of a length of time the user has been participating in a community.

37. The method of claim 31 wherein the one or more traits include the user's affiliation in a community.

38. The method of claim 31 wherein the one or more traits include an indication of a number of answer posts posted by the user.

39. The method of claim 31 wherein the one or more traits include an indication of a frequency with which the user votes.

40. The method of claim 31 wherein a first trait has a first impact on the weight and a second trait has a second impact on the weight, the first impact being different from the second impact.
